(19) United States
(12) Patent Application Publication
(10) Pub. No.: US 2014/0355444 A1
(43) Pub. Date: Dec. 4, 2014

(54) Method and Apparatus for Providing Routing

(71) Applicant: Broadcom Corporation, Irvine, CA (US)

(72) Inventors: Samuli TURTINEN, Ii (FI); Sami-Jukka HAKOLA, Kempele (FI); Jari Jaakko ISOKANGAS, Tampere (FI); Timo Kalevi KOSKELA, Oulu (FI)

(73) Assignee: Broadcom Corporation, Irvine, CA (US)

(21) Appl. No.: 14/288,978

(22) Filed: May 28, 2014

(30) Foreign Application Priority Data
May 29, 2013 (GB) 1309590.6

(51) Int. Cl. H04W 36/22; H04W 40/20

(52) U.S. Cl. CPC H04W 36/22; H04W 40/20
USPC 370/235

(57) ABSTRACT

A method, apparatus and computer program for providing an indication of network capability or providing data routing. An example method for use in a user equipment may comprise receiving an indication comprising a cell identification (ID) list that includes one or more cell IDs with which a local routing path is capable of being established, determining, with a processor, whether a cell ID of a second UE is on the cell ID list, a cell of the second STA having been identified, and in an instance in which the cell ID of the second STA is on the cell ID list, causing an indication for establishment of the local routing path for communication, the local routing path being between a first cell, the first cell serving the UE, and a second cell, the second cell serving the second UE, and communication being between the UE and the second UE.

### TECHNICAL FIELD

Embodiments of the present disclosure relate generally to a method, apparatus, and computer program product for indicating network capability and providing data routing.

### BACKGROUND

Recent growth in the use of mobile devices has led to an increase in network traffic. Proximity Services (ProSe) comprises user equipment (UE) discovery, i.e. discovery of another UE within proximity, based on direct radio signals between UEs or network side proximity detection, and establishment of optimized communication paths for UEs in proximity One option for a ProSe communication path is a local routing data path where an evolved Node B (eNB) (or, e.g., two neighbor eNBs) routes the traffic between a first UE and a second UE locally, thereby reducing impact on the core network (CN). Utilizing ProSe UE discovery, the UEs may be more aware of their neighboring UE devices and may observe whether they have an ongoing Internet Protocol (IP) connection with particular UE devices transmitting discovery signals in proximity. Hence, by means of UE discovery and enabling establishment of local routing data path, CN load may be reduced, for example.

### BRIEF DESCRIPTION OF THE DRAWINGS

Having thus described embodiments of the disclosure in general terms, reference will now be made to the accompanying drawings, which are not necessarily drawn to scale, and wherein:

FIG. 1 is block diagram of a system that may be specifically configured in accordance with an example embodiment of the present disclosure;

FIG. 2 is a block diagram of an apparatus that may be specifically configured in accordance with an example embodiment of the present disclosure;

FIGS. 3A-3D are example diagrams showing some embodiments of the present invention;

FIG. 4 is an example flowchart illustrating a method of operating an example apparatus in accordance with an embodiment of the present disclosure; and

FIG. 5 is an example flowchart illustrating a method of operating an apparatus in accordance with an example embodiment of the present disclosure.

### DETAILED DESCRIPTION

A method, apparatus and computer program product are therefore provided according to an example embodiment of the present disclosure for indicating network capability and/or providing a data routing. For example, the method, apparatus and computer program product may be applied to user equipment (UE) or an evolved node B (eNB) to facilitate a local routing path establishment.

In one embodiment, a method is provided for use in first user equipment (UE), the method comprising receiving an indication comprising a cell identifier (ID) list that includes one or more cell IDs with which a local routing path is capable of being established, determining, with a processor, whether a cell ID of a second UE is on the cell ID list and in an instance in which the cell ID of the second user equipment is on the cell ID list, causing an indication to be provided for establishment of the local routing path for communication, the local routing path being between a first cell, the first cell serving the first UE, and a second cell, the second cell serving the second UE, and communication being between the first UE and the second UE.

In another embodiment, a method is provided for use in a base station, the method comprising identifying one or more cell identifiers (ID) capable of establishing of a local routing path and causing an indication to one or more user equipments (UE) in a cell of the base station to be provided, the indication comprising one or more cell IDs with which the cell is capable of establishing a local routing path for communication.

In another embodiment, an apparatus for a first user equipment (UE) is provided, the apparatus comprising a processing system arranged to cause the apparatus to at least receive an indication comprising a cell identifier (ID) list that includes one or more cell IDs with which a local routing path is capable of being established, determine whether a cell ID of a second UE is on the cell ID list and in an instance in which the cell ID of the second user equipment is on the cell ID list, cause an indication to be provided for establishment of the local routing path for communication, the local routing path being between a first cell, the first cell serving the first UE, and a second cell, the second cell serving the second UE, and communication being between the first UE and the second UE.

The processing system may comprise at least one processor and at least on memory including computer program code.

In another embodiment, an apparatus is provided comprising a processing system arranged to cause the apparatus to at least identify one or more cell identifiers (ID) capable of establishing of a local routing path and cause an indication to one or more user equipments (UE) in a cell of a base station to be provided, the indication comprising one or more cell IDs with which the cell is capable of establishing a local routing path for communication.

The processing system may comprise at least one processor and at least on memory including computer program code.

In another embodiment, a computer program product is provided comprising a set of computer readable instructions that are executable on a processing system, the set of instructions comprising: code for receiving an indication comprising a cell identifier (ID) list that includes one or more cell IDs with which a local routing path is capable of being established, code for determining whether a cell ID of a second user equipment (UE) is on the cell ID list and in an instance in which the cell ID of the second user equipment is on the cell ID list, causing an indication to be provided for establishment of the local routing path for communication, the local routing path being between a first cell, the first cell serving a first UE, and a second cell, the second cell serving the second UE, and communication being between the first UE and the second UE.

The computer program product may comprise at least one non transitory computer readable medium on which the set is provided.

In another embodiment, a computer program product is provided comprising a set of computer readable instructions that are executable on a processing system, the set of instructions comprising: code for identifying one or more cell identifiers (ID) capable of establishing of a local routing path and causing an indication to one or more user equipments (UE) in a cell of a base station to be provided, the indication comprising one or more cell IDs with which the cell is capable of establishing a local routing path for communication.

The computer program product may comprise at least one non transitory computer readable medium on which the set is provided. In another embodiment, an apparatus for a first user equipment (UE) is provided, the apparatus comprising means for receiving an indication comprising a cell identifier (ID) list that includes one or more cell IDs with which a local routing path is capable of being established and means for determining, with a processor, whether a cell ID of a second UE is on the cell ID list and in an instance in which the cell ID of the second user equipment is on the cell ID list, means for causing an indication to be provided for establishment of the local routing path for communication, the local routing path being between a first cell, the first cell serving the first UE, and a second cell, the second cell serving the second UE, and communication being between the first UE and the second UE.

In another embodiment, an apparatus is provided comprising means for identifying one or more cell identifiers (ID) capable of establishing of a local routing path and means for causing an indication to one or more user equipments (UE) in a cell of a base station to be provided, the indication comprising one or more cell IDs with which the cell is capable of establishing a local routing path for communication.

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present disclosure.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

A method, apparatus and computer program product are provided in accordance with example embodiments of the present disclosure in order to, for example, indicate a network capability and/or provide a data routing.

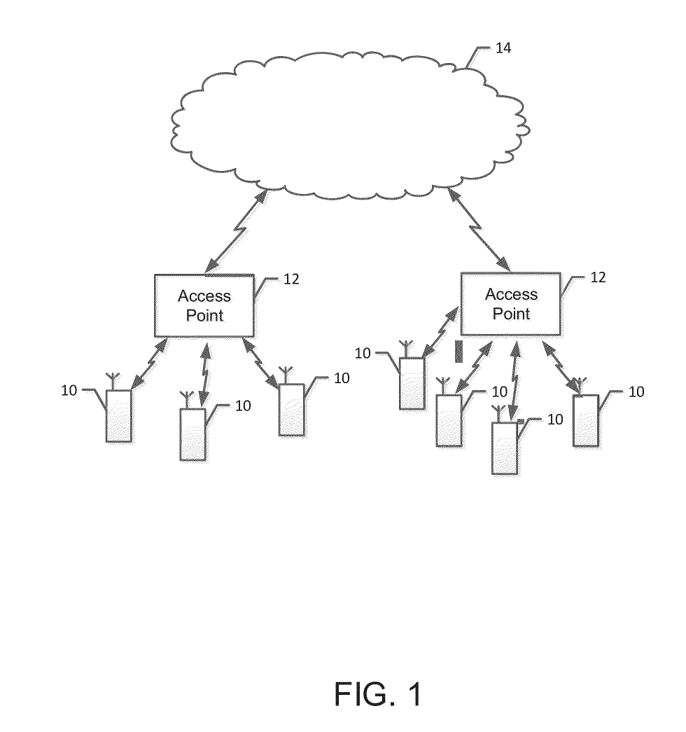

Referring now to FIG. 1, which illustrates an example system that supports communications between a plurality of stations 10 and one or more access points 12 (e.g., a high density system scenario where a plurality of access points may be deployed to a geographical area and may be operating on the same frequency channel), each access point may communicate with one or more stations and, in one embodiment, may communicate with a large number of stations, such as 6,000 or more stations. The access points may, in turn, communicate with a network 14. While the access points may communicate via an Long Term Evolution (LTE) or LTE-Advanced (LTE-A) network, other networks may support communications between the access points including those configured in accordance with wideband code division multiple access (W-CDMA), CDMA2000, global system for mobile communications (GSM), general packet radio service (GPRS), the IEEE 802.11 standard including, for example, the IEEE 802.11ah or 802.11ac standard or other newer amendments of the standard, wireless local access network (WLAN), Worldwide Interoperability for Microwave Access (WiMAX) protocols, universal mobile telecommunications systems (UMTS) terrestrial radio access network (UTRAN) and/or the like.

The access points 12 and the stations 10 may communicate via wireline communications, but most commonly communicate via wireless communications. For example, the access points and the stations may communicate in a sub 1 GHz band as defined by IEEE 802.11ah standard or in a 5 GHz band, which may be defined by, for example, IEEE 802.11ac standard. The access point may be embodied by any of a variety of network entities, such as an access point, a base station, a Node B, an evolved Node B (eNB), a radio network controller (RNC), a mobile device/a station (e.g., mobile telephones, smart phones, portable digital assistants (PDAs), pagers, laptop computers, tablet computers or any of numerous other hand held or portable communication devices, computation devices, content generation devices, content consumption devices, or combinations thereof), or the like. The stations may also be embodied by a variety of devices, such as sensors, meters or the like. The sensors and meters may be deployed in a variety of different applications including in utility applications to serve as a gas meter, a water meter, a power meter or the like, in environmental and/or agricultural monitoring applications, in industrial process automation applications, in healthcare and fitness applications, in building automation and control applications and/or in temperature sensing applications. Stations that are embodied by sensors or meters may be utilized in some embodiments to backhaul sensor and meter data. Alternatively, the stations may be embodied by mobile terminals or user equipment(s) (UE), such as mobile communication devices, e.g., mobile telephones, smart phones, portable digital assistants (PDAs), pagers, laptop computers, tablet computers or any of numerous other hand held or portable communication devices, computation devices, content generation devices, content consumption devices, or combinations thereof. In an embodiment in which the station is embodied by a mobile terminal, the communication between an access point and the station may serve to extend the range of wi-fi or another wireless local area network (WLAN), such as by extending the range of a hotspot, and to offload traffic that otherwise would be carried by a cellular or other network.

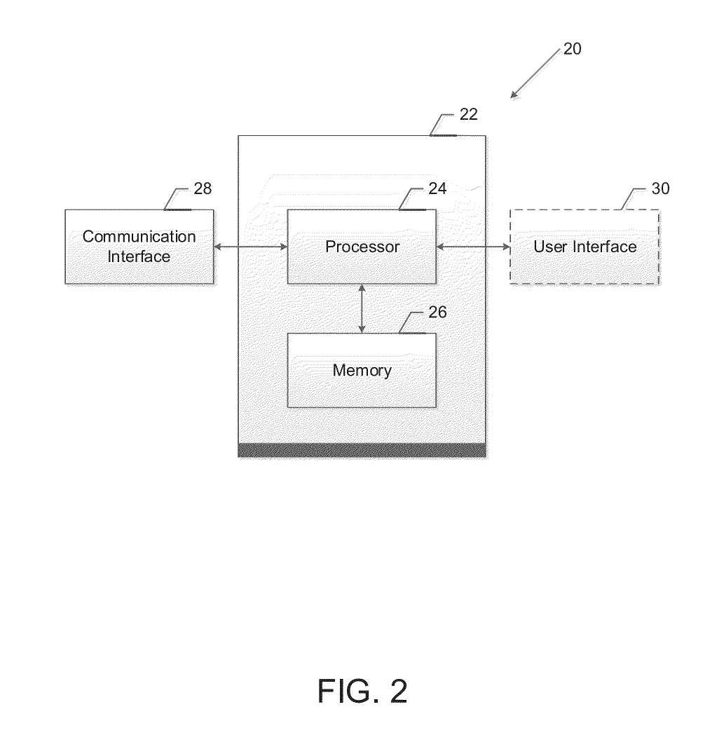

The access point 12 and/or the station 10 may be embodied as or otherwise include an apparatus 20 that is specifically configured to perform the functions of the respective device, as generically represented by the block diagram of FIG. 2. While the apparatus may be employed, for example, by an access point or a station, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with some example embodiments described herein. The processing circuitry may be configured to perform data processing, application execution, signal processing, measurements and report generation, and/or other processing and management services according to an example embodiment of the present disclosure. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present disclosure on a single chip or as a single “system on a chip.” As such, in some cases, a chip or chipset may constitute means for performing one or more operations for providing the functionalities described herein. Alternatively or additionally, a processing system may be embodied by or have similar functionality to the processing circuitry.

In an example embodiment, the processing circuitry 22 may include a processor 24 and memory 26 that may be in communication with or otherwise control a communication interface 28 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments, the processing circuitry may be embodied as a portion of the mobile terminal 10.

The user interface 30 (if implemented) may be in communication with the processing circuitry 22 to receive an indication of a user input at the user interface and/or to provide an audible, visual, mechanical or other output to the user. In this regard, the user interface and/or the processing circuitry 22 may include user interface circuitry configured to facilitate user control of at least some functions based upon user input. The user interface may include, for example, a keyboard, a mouse, a trackball, a display, a touch screen, a microphone, a speaker, and/or other input/output mechanisms. The apparatus 20 need not always include a user interface.

The communication interface 28 may include one or more interface mechanisms for enabling communication with other devices and/or networks, such as for enabling communication between an access point 12 and a station 10 or between two or more stations. In some cases, the communication interface may be any means such as a device or circuitry embodied in either hardware, or a combination of hardware and software that is configured to receive and/or transmit data from/to a network and/or any other device or module in communication with the processing circuitry 22. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present disclosure. For example, the memory may be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an application specific integrated circuit (ASIC), an field programmable gate array (FPGA), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present disclosure while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

A method, apparatus and computer program product are provided in accordance with an example embodiment of the present disclosure in order to indicate network capability. In one embodiment, a network, for example an Evolved Universal Terrestrial Radio Access Network (E-UTRAN) or network node, such as an enhanced Node B (eNB), may provide an indication, for example in one of its cells, including the neighbor cell identifiers IDs (e.g., Physical Cell ID (PCI), E-UTRAN Cell Global Identifier (ECGI) or the like) to the user equipment (UE) with which the given cell or for example, the eNB handling a serving cell may establish a local routing path for communication. In some embodiments, for example in connected mode, the cell ID list may be received from a serving eNB, such as the eNB that the UE is connected to when the UE is in a RRC_CONNECTED state. In other embodiments, the cell ID list may be received from an eNB that the UE has selected to camp on if data communication were to be enabled, for example when the UE is an RRC_IDLE state. In some embodiments, the local routing path may be between a first cell, the first cell serving a first UE, and a second cell, the second cell serving a second UE, and the communication may be between the first UE and the second UE. In some embodiments, it may be assumed that the UEs transmitting UE discovery signals include their current serving cell ID (e.g., PCI, ECGI or the like) in their discovery signal. A discovery signal, as identified in the 3GPP ProSe study, enables UEs to discover each other by means of direct radio signals. In some embodiments, the current serving cell ID may be included into another signal sent directly between the UEs. Alternatively, in some embodiments, the current serving cell ID may be sent via network (for example using Session Initiation Protocol (SIP) messages e.g. SIP setup). The serving cell ID may be the UE's Primary Cells (PCells), any of the UE's Secondary Cells (SCells), the cell in which the UE discovery signal is transmitted, etc. In some embodiments, a local routing path may be a routing path not supported by the core network or, indeed, any of the network other than the eNBs with which the UEs are in communication. In some embodiments, a router comprises a UE and in some embodiments, a UE act as a router.

In some embodiments, a UE may assume the serving cell is able to conduct local routing between UEs in that same cell if the serving cell broadcasts the neighbor cell ID list with which local routing is possible. Additionally or alternatively, a UE may assume the serving cell is able to conduct local routing between UEs if an eNB indicates that the cell_ID of the given cell is included in the list. Additionally or alternatively, a UE may assume the serving cell is able to conduct local routing between UEs if a bit is indicated in broadcast information/dedicated radio resource control (RRC) configuration that the serving cell is able to conduct local routing.

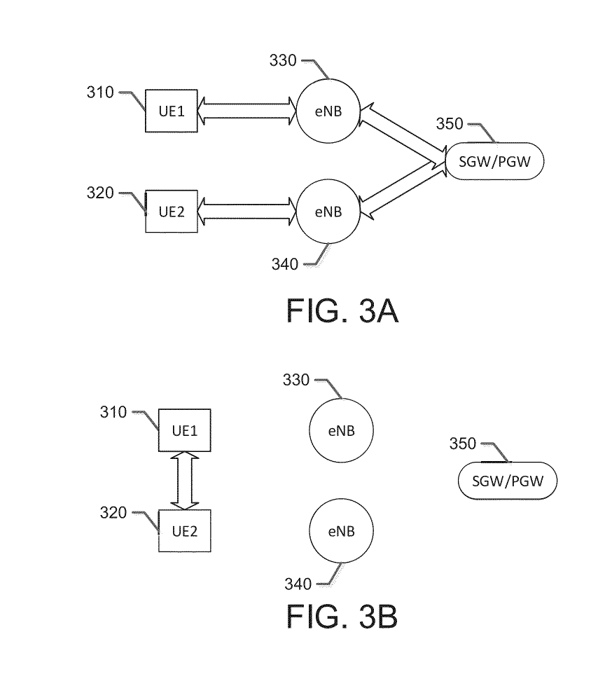

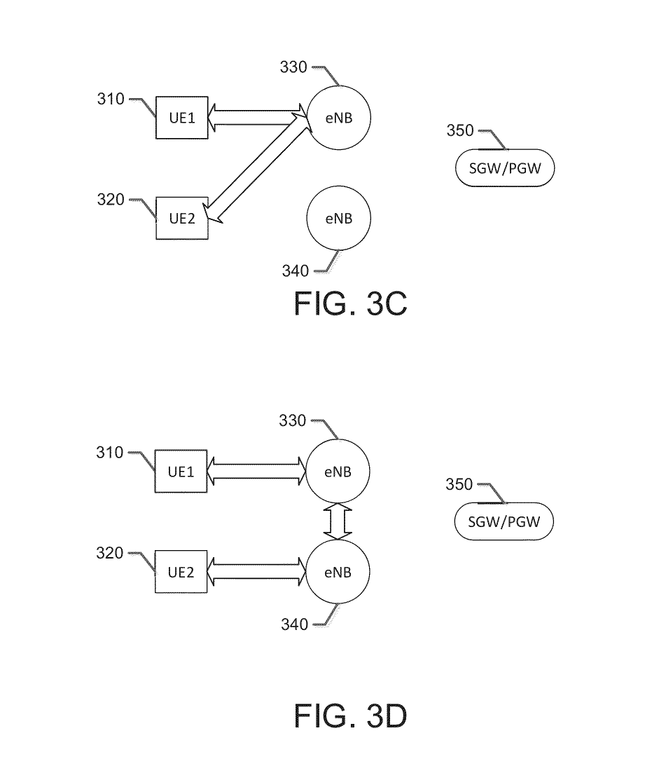

FIG. 3A is a diagram showing a data path set up, for example via Evolved Packet System (EPS), for communication between two UEs. In one embodiment, when two UEs, 310 and 320 communicate with each other, their data path (user plane) goes is established the operator network. The data path for this type of communication is shown in FIG. 3A, where eNB(s) 330 and 340 and/or serving gateway (SGW)/packet data network (PDN) gateway (PGW)(s) 350 are involved. FIG. 3B is a diagram showing a direct mode data path for communication between two UEs. For example, if UEs 310 and 320 are in proximity of each other, they may be able to use a local or direct path. For example, in 3GPP LTE spectrum, an operator may move the data path (user plane) off the core network (CN) onto direct links between the UEs. This direct data path is shown in FIG. 3B. FIG. 3C shows a “locally-routed” data path in the network (e.g. E-UTRAN), for communication between two UEs when UEs are served by the same eNB. FIG. 3D shows a “locally-routed” data path for communication between to UEs when served by different eNBs.

FIG. 3D is a diagram showing a local routing between two cells 310 and 320, and between two eNBs 330 and 340. In one embodiment, by broadcasting the neighbor cell IDs with which the current serving cell of the given UE may establish a local routing path, UE 310 discovers a second UE 320 that resides in a second cell, wherein the cell ID may for example have been conveyed in the discovery signal. The cell_ID may have been communicated to other UE, e.g., in session setup message, earlier when communication link had been established via infrastructure path, etc. UE1 310 may check whether the cell ID2 is capable of local routing with the given serving cell. If the cell ID2 is capable of local routing with cell_ID1, UE1 310 or UE2 320 may trigger the local routing path switch to, for example, EPC session management (e.g., in Mobility Management Entity (MME). In some embodiments, a local routing path may be established between, for example three or more UEs, where each is served by a different eNB. In one example embodiment, groupcast and/or broadcast communications may be utilized to support one or more local routing paths between three or more UEs, where each may be served by a different eNB In some embodiments, a local routing path may be established via three or more eNBs, which provide local routing path for two UEs. The cell ID list may then comprise also the chains of the neighbor cell IDs providing routing paths.

As shown above, one option for a ProSe communication path is a local routing data path where eNB 330 (or, e.g., two neighbor eNBs 330 and 340) routes the traffic between UE1 310 and UE2 320 locally without support from the CN. In one embodiment, this may be done, e.g., via Xn-interface (like X2-interface) or a proprietary interface inside an eNB.

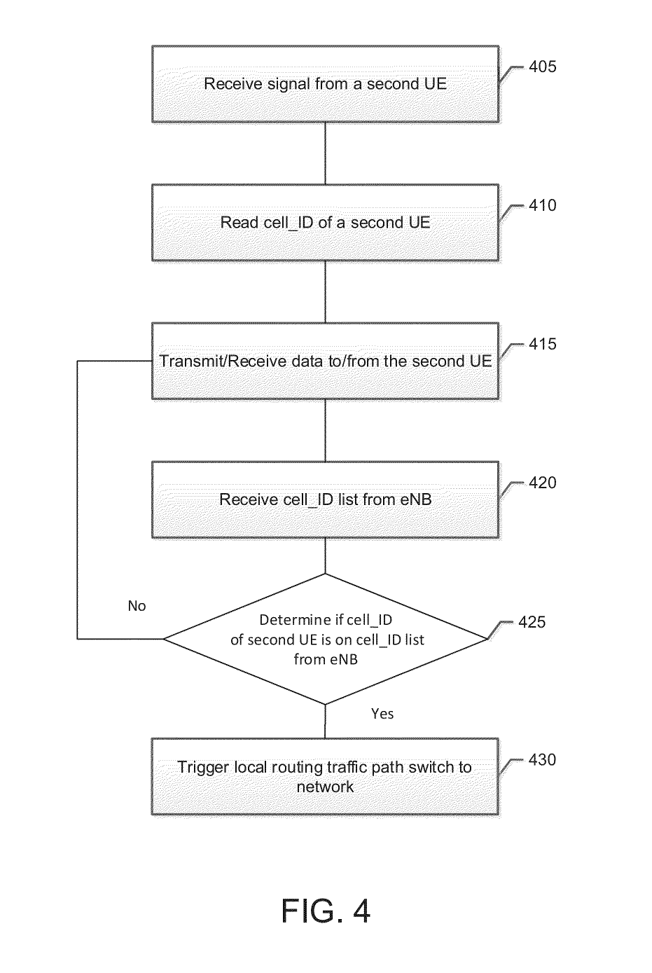

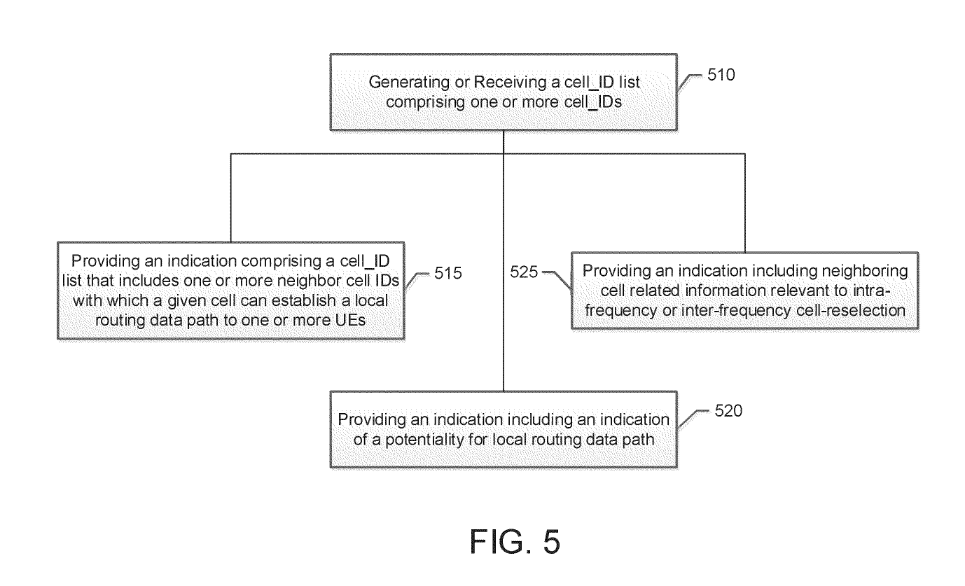

FIGS. 4 and 5 illustrate example flowcharts of the example operations performed by a method, apparatus and computer program product as embodied or otherwise associated with a station, such as a UE (or part of the UE e.g. a modem), or an access point, respectively, in accordance with an embodiment of the present disclosure. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present disclosure and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 4 and 5 when executed, convert a computer or processing circuitry into a particular machine configured to perform an example embodiment of the present disclosure. Accordingly, the operations of FIGS. 4 and 5 define an algorithm for configuring a computer or processing to perform an example embodiment. In some cases, a general purpose computer may be provided with an instance of the processor which performs the algorithms of FIGS. 4 and 5 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations above either alone or in combination with any others among the features described herein. As would be appreciated by one skilled in the art, the operations herewith are not restricted to the order given, and the invention is not limited to the embodiments shown. Different combinations of functions as well as an alternative order may be utilized in some embodiments.

Referring now to FIG. 4, operations are shown for a method of operation for use in a station (STA), such as user equipment (UE). In some embodiments, stations that are embodied by mobile terminals or user equipment(s) (UE), such as mobile communication devices, e.g., mobile telephones, smart phones. The operations may be performed by an apparatus 20, such as illustrated in FIG. 2, embodied by a UE or part of the UE (e.g., a modem), and will be hereinafter described. FIG. 4 is an example flowchart illustrating a method for use in a UE for establishing a local routing path for communication with a second UE.

Referring now to block 405 of FIG. 4, the apparatus may include means, such as the processing circuitry 22, the processor 24 or the like, for receiving a signal (e.g., a discovery signal) from a second UE. In some embodiments, the cell ID of a UE is included in the signal (e.g., a discovery signal). Referring now to block 410 of FIG. 4, the apparatus may include means, such as the processing circuitry 22, the processor 24 or the like, for reading the cell_ID of the second UE. In one example embodiment, ProSe UE discovery may enable two or more UEs to discover each other by means of direct radio signals. UE1 310 may discover UE2 320 and the UE2 320 may convey its serving cell ID (like ECGI) in its discovery signal.

In some embodiments of the present disclosure, the apparatus may include means, such as the processing circuitry 22, the processor 24 or the like, for transmitting data to the second UE and/or receiving data from the second UE, for example via the network. See block 415 of FIG. 4. For example, in some embodiments, no direct data communication occurs in the process of establishing a local routing path. In some embodiments, the data communication may not be via direct radio path but rather via a network. In some embodiments, the data communication may not be via direct radio path or via a network (e.g. EPC) before the establishment of the local routing path. In some embodiments, the UE may be configured to determine that existing data communication with the UE2 exists, e.g., one or more IP flows etc.

Referring now to block 420 of FIG. 4, the apparatus may include means, such as the processing circuitry 22, the processor 24 or the like, for receiving a cell_ID list from an eNB. Referring now to block 425 of FIG. 4, the apparatus may include means, such as the processing circuitry 22, the processor 24 or the like, for determining if the cell_ID of the second UE is on the cell_ID list received from the eNB. In some embodiments, for example in connected mode, the cell ID list may be received from a serving eNB, such as the eNB that the UE is connected to when the UE is in a RRC_CONNECTED state. In other embodiments, the cell ID list may be received from an eNB that the UE has selected to camp on if data communication were to be enabled, for example when the UE is an RRC_IDLE state.

In an instance in which the cell_ID of the second UE is on the cell_ID list received from the eNB, the process may proceed to bock 430. Referring now to block 430 of FIG. 4, the apparatus may include means, such as the processing circuitry 22, the processor 24 or the like, for causing an indication for establishment of or the triggering of a local routing path switch to network. The triggering or establishment of a local routing path may be facilitated via, e.g., a service request to EPC session management (MME) wherein it may be indicated that local routing is possible. In an instance in which there is ongoing communication, the UE may indicate to MME, e.g., with a bearer modification request which IP flows could be associated with local routing path with the UE2 etc. In for example, public safety specific scenarios, UEs may be configured to conduct device to device (D2D) without NW involvement. In such an instance, the indication may also be sent to the eNB.

In an instance in which the cell_ID of the second UE is not on the cell ID list received from the eNB, indicating that a local routing path may not be triggered. In some embodiments, the process may proceed to step 415, such that the UE may start or continue to transmit via the network.

Referring now to FIG. 5, operations are shown for a method of operation for use in a base station, such as an eNB. The operations may be performed by an apparatus 20, such as illustrated in FIG. 2, embodied by a computing device 10, and will be hereinafter described. FIG. 5 is an example flowchart illustrating a method for use in an eNB for providing an indication of network capability.

Referring now to block 510 of FIG. 5, the apparatus may include means, such as the processing circuitry 22, the processor 24, the communication interface 28 or the like, for receiving one or more cell IDs with which a local routing path can be established. In one embodiment, a cell_ID list may be generated that includes the one or more cell_IDs provided by the E-UTRAN. In one embodiment, the network, for example E-UTRAN network, may indicate in one of its cells, the neighbor cell IDs (e.g., PCI, ECGI or the like) to the UE with which the given cell can establish a local routing data path. In some embodiments, the one or more cell IDs may be signaled between eNBs. For example, for load balancing purposes a particular eNB may signal to another eNB not to distribute its cell IDs due to high load etc. In another embodiment, the cell_ID list may be provided by the operator, e.g. via O&M, EPC may provide, or a ProSe server, etc.

Referring now to block 515 of FIG. 5, the apparatus may include means, such as the processing circuitry 22, the processor 24, the communication interface 28 or the like, for providing an indication comprising a cell_ID list including one or more cell IDs with which a given cell can establish a location routing data path to one or more UEs. The indication may be sent via broadcast signaling, e.g., in a System Information Block (SIB). The indication may also be sent dedicatedly to a selected UE(s), e.g., via radio resource control (RRC) signaling.

Referring now to block 520 of FIG. 5, the apparatus may include means, such as the processing circuitry 22, the processor 24, the communication interface 28 or the like, for providing an indication including an indication of a potentiality for local routing data path. For example, in one embodiment, the indication corresponding to a certain cell may be transmitted along with a measurement object configuring the cell for a measObject for the given UE, thus indicating the potentiality for local routing data path.

Referring now to block 525 of FIG. 5, the apparatus may include means, such as the processing circuitry 22, the processor 24, the communication interface 28 or the like, for providing an indication including neighboring cell related information relevant to intra-frequency or inter-frequency cell reselection. For example, in one embodiment, the indication corresponding to a certain cell may be transmitted along with IntraFreqNeighCellInfo or InterFreqNeighCellInfo information elements (IEs) in SIB4 or SIB5, respectively, which contain neighboring cell related information relevant for intrafrequency or inter-frequency E-UTRA cell-reselection, respectively. In one embodiment, the network indication of neighbor cell IDs indicates to UE the network (NW) capability for local routing.

In an alternative embodiment, in response to a decoded signal (e.g. a discovery signal) from one UE in another cell, the one UE may query its serving cell node (namely the eNB that serves the one UE) whether local routing with the cell is possible. This may be done before the service request/bearer modification request to session management so that the possibility for local routing data path may be indicated simultaneously or near simultaneously.

In one embodiment, EPC, which may include one or more additional network nodes, (by means of ProSe server, for instance) may assist eNB in determining when and/or for which cells to indicate local routing possibility to UEs, such as in a cell ID list.

The eNB may take several factors into consideration when deciding and/or determining the cell IDs to indicate as local routing possibilities, such as a cell ID list. Such factors may include but not are limited to, e.g., EPC load/backhaul quality, link (e.g., X2-interface) quality between the associated nodes, link latency between the associated nodes, load in the given cell or neighboring cells, the amount of ProSe enabled UEs transmitting UE discovery signals in certain cells, etc. For example, if EPC backhaul quality and/or link quality is determined to meet a predetermined threshold or drop below a predetermined threshold, possibility of a local routing path establishment may be increased or reduced.

In some embodiments of the present invention, by making one or more cell IDs that may be involved with local routing data path to a UE, the UE is able to trigger local routing data path establishment by means of Prose UE discovery. In some embodiments of the present invention, load balancing is made possible between EPC and E-UTRAN as well as internally in E-UTRAN as eNBs may selectively indicate the cell IDs for local routing based on, e.g., load situations in backhauls etc. In some embodiments of the present invention, transmission in SIB may also enable IDLE mode UEs, indicating the availability of local routing data path in a service request while dedicated RRC configuration may be for CONNECTED mode UEs.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for use in a first user equipment (UE), the method comprising:
receiving an indication comprising a cell identifier (ID) list that includes one or more cell IDs with which a local routing path is capable of being established;
determining whether a cell ID of a second UE is on the cell ID list; and
in an instance in which the cell ID of the second user equipment is on the cell ID list, causing an indication to be provided for establishment of the local routing path for communication, the local routing path being between a first cell, the first cell serving the first UE, and a second cell, the second cell serving the second UE, and communication being between the first UE and the second UE.

2-3. (canceled)

4. The method according to claim 1, further comprising:
receiving an indication of a potentiality for establishment of the local routing path; and
causing transmission of a query to the first cell for determining a capability of the local routing path establishment.

5. (canceled)

6. The method according to claim 1, further comprising:
receiving the signal from the second UE, wherein the signal comprises the cell ID of the second UE.

7-8. (canceled)

9. The method according to claim 1, further comprising:
receiving the indication via Radio Resource Control (RRC) signalling or receiving the indication via System Information Block (SIB) signalling; and
receiving neighboring cell related information relevant to intra-frequency or inter-frequency cell-reselection.

10-21. (canceled)

22. An apparatus for controlling a fist user equipment (UE), the apparatus comprising a processing system which comprises circuitry and at least one memory including computer program code, wherein the processing system is arranged to cause the first user equipment to at least:
receive an indication comprising a cell identifier (ID) list that includes one or more cell IDs with which a local routing path is capable of being established;
determine whether a cell ID of a second UE is on the cell ID list; and
in an instance in which the cell ID of the second UE is on the cell ID list, cause an indication to be provided for establishment of the local routing path for communication, the local routing path being between a first cell, the first cell serving the first UE, and a second cell, the second cell serving the second UE, and communication being between the first UE and the second UE.

23. (canceled)

24. The apparatus according to claim 22, wherein the indication comprising the cell ID list is received from an enhanced Node B (eNB).

25. The apparatus according to claim 22, wherein the processing system is further arranged to cause the first user equipment to:
receive an indication of a potentiality for establishment of a local routing path.

26. The apparatus according to claim 22, wherein the first cell is the second cell, the first cell and the second cell being provided by a single base enhanced Node B (eNB), or the first cell and the second cell being provided by a first eNB and a second eNB, respectively.

27. The apparatus according to claim 22, wherein the processing system is further arranged to cause the first user equipment to:
receive a signal from a second UE, wherein the signal comprises the cell ID of the second UE.

28. The apparatus according to claim 27, wherein the signal comprises a discovery signal.

29. The apparatus according to claim 22, wherein the processing system is further arranged to cause the first user equipment to:
transmit a query to the first cell for determining a capability of a local routing path establishment.

30. The apparatus according to claim 22, wherein the processing system is further arranged to cause the first user equipment to:
receive the indication via Radio Resource Control (RRC) signaling or receive the indication via System Information Block (SIB) signaling.

31. The apparatus according to claim 30, wherein the processing system is further arranged to cause the first user equipment to: receive neighboring cell related information relevant to intra-frequency or inter-frequency cell-reselection

32. The apparatus according to claim 22, wherein the cell ID being at least one of a Physical Cell ID (PCI) and E-UTRAN Cell Global Identifier (ECGI).

33. (canceled)

34. The apparatus according to claim 22, wherein the apparatus is configured for use in an Long Term Evolution (LTE) or LTE-Advanced (LTE-A) system.

35. An apparatus for controlling a base station, a Node B (Nb) or an enhanced node B (eNB), comprising a processing system which comprises circuitry and at least on memory including computer program code, wherein the processing system is arranged to cause the base station, NB or eNB to at least:
identify one or more cell identifiers (ID) capable of establishing of a local routing path; and
provide an indication to one or more user equipments (UE) in a cell, the indication comprising one or more cell IDs with which the cell is capable of establishing a local routing path for communication.

36. (canceled)

37. The apparatus according to claim 35, wherein the indication is provided to a first UE, and the local routing path being between a first cell, the first cell serving the first UE, and a second cell, the second cell serving a second UE, and communication being between the first UE and the second UE, wherein the indication is delivered via Radio Resource Control (RRC) signalling or via System Information Block (SIB) signalling.

38. (canceled)

39. The apparatus according to claim 35, wherein the processing system is arranged to cause the base station, NB or eNB to:
provide an indication including an indication of a potentiality for local routing data path; and
provide an indication including neighboring cell related information relevant to intra-frequency or inter-frequency cell-reselection.

40. (canceled)

41. The apparatus according to claim 35, wherein the one or more cell IDs included in the indication are identified based on one or more of a load or backhaul quality, link quality, link latency, an amount of UEs transmitting discovery signals in one or more particular cells.

42. (canceled)

43. The apparatus according to claim 35, wherein the processing system is arranged to cause the base station, NB or eNB to:
receive a query from the UE for determining a capability of a local routing path establishment; and
cause establishment of the local routing path in response to receiving an indication requesting establishment of the local routing path.

44-88. (canceled)
